(19) United States
(12) Patent Application Publication
(10) Pub. No.: US 2025/0115201 A1
(43) Pub. Date: Apr. 10, 2025

(54) EMBEDDED ELECTRICAL CONTROLS FOR A VEHICLE

(71) Applicant: Oshkosh Corporation, Oshkosh, WI (US)

(72) Inventors: Matthew Mortenson, Oshkosh, WI (US); Naveen Kumar, Oshkosh, WI (US); Kabir Hassan, Oshkosh, WI (US); Kevin Christian, Oshkosh, WI (US); Thomas Vale, Oshkosh, WI (US); Ismet Hamzagic, Oshkosh, WI (US)

(73) Assignee: Oshkosh Corporation, Oshkosh, WI (US)

(21) Appl. No.: 18/906,949

(22) Filed: Oct. 4, 2024

Related U.S. Application Data
(60) Provisional application No. 63/542,891, filed on Oct. 6, 2023.

(51) Int. Cl. B60R 16/08; B60R 16/033

(52) U.S. Cl. CPC B60R 16/08; B60R 16/033

(57) ABSTRACT

A vehicle can include an assembly, a body, a first connection point, and a second connection point. The first connection point can be disposed on a surface of the body. The first connection point can receive a first element of the assembly. The first connection point can couple the first element with the body to provide structural support to at least one of the assembly or the body. The second connection point can be disposed on the surface of the body. The second connection point can be adjacent to the first connection point. The second connection point can receive a second element of the assembly that is configured to provide an electrical connection or a hydraulic connection between the body and the assembly.

### CROSS-REFERENCE TO RELATED PATENT APPLICATIONS

This application claims the benefit of and priority to U.S. Provisional Patent Application No. 63/542,891, filed Oct. 6, 2023, the entire contents of which are incorporated by reference herein.

### BACKGROUND

The present disclosure relates to assembling one or more components of a vehicle that include electrical connections.

### SUMMARY

One embodiment of the present disclosure relates to a vehicle. The vehicle includes an assembly and a body. The body includes a first face. The first face includes a first connection point and a second connection point. The first connection point receives a first element of the assembly. The second connection point is disposed adjacent to the first connection point and the second connection portion and receives a second element of the assembly. The first connection point couples the first element of the assembly with the body. The second connection point establishes communication between the second element of the assembly and the vehicle.

In some embodiments, establishing communication between the second element of the assembly and the vehicle includes at least one of establishing a fluid connection between the second element of the assembly and the vehicle, or electrically coupling the second element of the assembly with the vehicle.

In some embodiments, the assembly includes at least one of a tailgate, a chassis, an ejector, or a bulkhead.

At least one embodiment relates to a vehicle. The vehicle can include an assembly. The vehicle can include a body. The vehicle can include a first connection point. The first connection point can be disposed on a surface of the body. The first connection point can receive a first element of the assembly. The first connection point can couple the first element with the body to provide structural support to at least one of the assembly or the body. The vehicle can include a second connection. The second connection point can be disposed on the surface of the body. The second connection point can be adjacent to the first connection point. The second connection point can receive a second element of the assembly that is configured to provide an electrical connection or a hydraulic connection between the body and the assembly.

At least one embodiment relates to a method. The method can include aligning a first connection point on a body of a vehicle with a first element of an assembly of the vehicle. The first connection point can structurally couple the assembly onto the body. The method can include causing, responsive to aligning the first connection point, an alignment of a second element of the assembly with a second connection point on the body. The second connection point can be adjacent to the first connection point. The second connection point can receive the second element of the assembly. The second connection point can provide an electrical connection or a hydraulic connection between the body and the assembly.

At least one embodiment relates to a body. The body can be for a vehicle. The body can include a first junction for structural connections between the body and one or more first assemblies of the vehicle. The body can include a second junction for electrical connections between the body and one or more first elements of the vehicle. The body can include a third junction for hydraulic connections between the body and one or more second elements of the vehicle. The first junction, the second junction, and the third junction can be adjacent to one another.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1, according to an exemplary embodiment.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle, according to an exemplary embodiment.

FIG. 5 is a perspective view of a vehicle including one or more connection points, according to an exemplary embodiment.

FIG. 6 is a side view of the vehicle illustrated in FIG. 5, according to an exemplary embodiment.

FIG. 7 is a perspective view of a first portion of the side view of the vehicle illustrated in FIG. 6, according to an exemplary embodiment.

FIG. 8 is a perspective view of a first portion of the side view of the vehicle illustrated in FIG. 6, according to an exemplary embodiment.

FIG. 9 is a perspective view of the vehicle illustrated in FIG. 5, according to an exemplary embodiment.

FIG. 10 is a perspective view of the vehicle illustrated in FIG. 5, according to an exemplary embodiment.

FIG. 11 is a perspective view of a first portion of the vehicle illustrated in FIG. 10, according to an exemplary embodiment.

FIG. 12 is a perspective view of the vehicle illustrated in FIG. 5, according to an exemplary embodiment.

FIG. 13 is a perspective view of the vehicle illustrated in FIG. 5, according to an exemplary embodiment.

FIG. 14 is a perspective view of the vehicle illustrated in FIG. 5, according to an exemplary embodiment.

FIG. 15 is a perspective view of the vehicle illustrated in FIG. 5, according to an exemplary embodiment.

FIG. 16 is a perspective view of the vehicle illustrated in FIG. 5, according to an exemplary embodiment.

FIG. 17 is a perspective view of an electrical panel included in the vehicle illustrated in FIG. 6, according to an exemplary embodiment.

FIG. 18 is a flow diagram of a method of assembly of one or more components of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Vehicles may include components, elements, and/or equipment. For example, a refuse vehicle may include a tailgate. The tailgate may be coupled with or otherwise attached to a component of the refuse vehicle. For example, the tailgate may be connected to a body of the refuse vehicle. The body of the refuse vehicle may include one or more connection points. For example, the body may include a bracket. The bracket may receive a portion or element of the tailgate. In some embodiments, a fastener couples the tailgate to the body of the refuse vehicle. The coupling of the tailgate with the body refuse vehicle may include a mechanical connection (e.g., a structural coupling that secures the tailgate to the body, etc.). For example, a first mechanical element (e.g., the tailgate) is coupled with a second mechanical element (e.g., the body of the refuse vehicle). The coupling of the tailgate with the body of the refuse vehicle may also include fluid and/or electrical connections. For example, a cable disposed within the tailgate may be electrically coupled with the refuse vehicle (e.g., an electrical connection).

Other structural components of the vehicle assembly may include mechanical connections, fluid connections, and/or electrical connections to the chassis and/or one another. The various types of connections may provide several challenges as mechanical, fluid, and electrical connections may occur at different points across the vehicle assembly. For example, an arm assembly of a vehicle may be coupled with a body of the vehicle at a first location and a hydraulic system, for the arm assembly, may be coupled with the vehicle at a second location. The first location and the second location may be separated and/or isolated from one another (e.g., the first location is inaccessible from the second location or vice versa). As another example, a mechanical connection between a first element and a second element of a vehicle may include an operator or an installer climbing on top of the vehicle to perform the mechanical connections, while an electrical connection between the first element and the second element may include the installer sliding underneath a chassis of the vehicle.

Various embodiments of the present disclosure include vehicles having connection points that are proximate to one another to facilitate and streamline assembly operations. For example, a mechanical connection point between two elements may be located next to or adjacent to an electrical connection point between the same two elements. Stated differently, a first element and a second element of vehicle may have mechanical connection points located next to electrical connection points. The location of the connection points (e.g., located proximate or adjacent to) may streamline and improve assembly of vehicles as connections between elements of the vehicle may be performed from a single location and without the need for an operator to enter tight spaces or enclosed regions along the vehicle. For example, each connection may be within arm's reach from one another such that an operator of the vehicle can reach each connection without having to move or otherwise reposition themselves. While some of the connections described herein include mechanical connections or electrical connections, in should be understood that the connections may be of various other types. For example, the fluid connections may include liquid or gaseous connections (e.g., hydraulic, Compressed Natural Gas, vehicle fluids, etc.).

In some embodiments, two different types of connections (e.g., a mechanical connection and an electrical connection) may be situated so that both connections are made at substantially the same time (e.g., simultaneously) during assembly. For example, the electrical connections on the vehicle body and the tailgate may be positionally aligned with one another such that, during assembly, the electrical connection is made without requiring a separate operation.

### Overall Vehicle

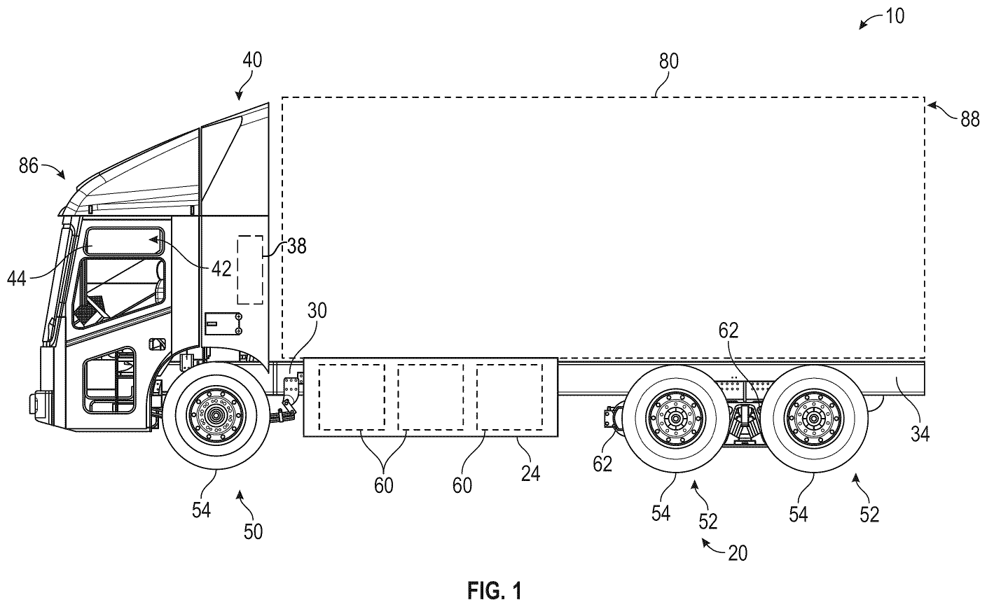

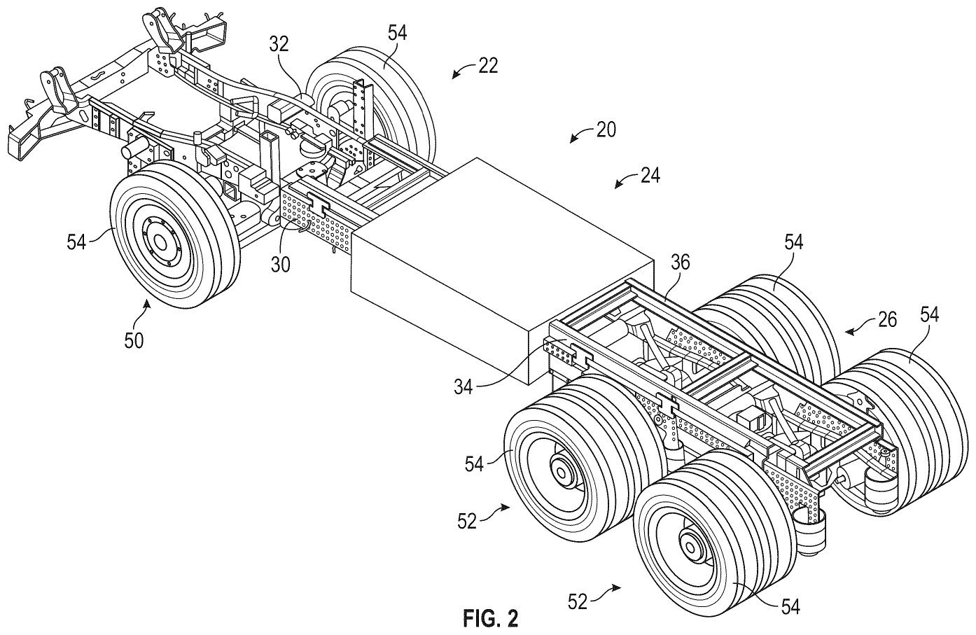

Referring to FIGS. 1 and 2, a vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front-end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

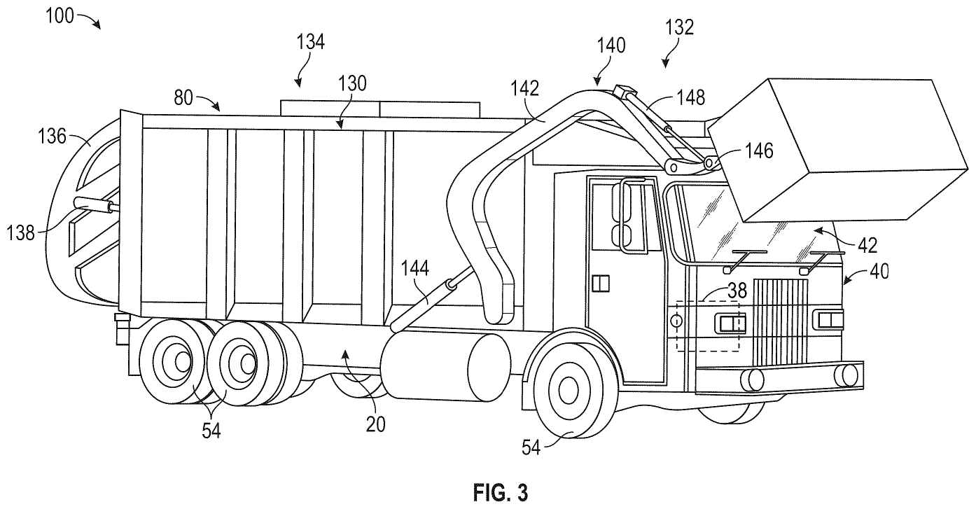

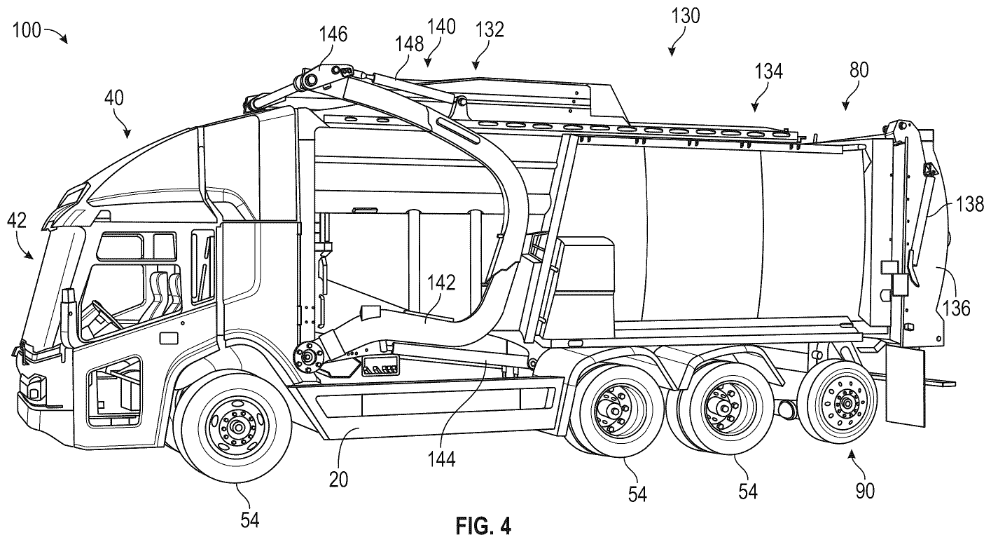

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, the vehicle 10 may be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-4 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

The vehicle 10 includes a controller 38 that is configured to operate any of the motors, actuators, components, implements, and/or elements of the various vehicles described herein. For example, the application kit 80 may be controllable by the controller 38. In some embodiments, the controller 38 may receive sensory input from sensors disposed on the vehicle 10. The controller 38 may generate control signals to operator any of the vehicle components described herein. For example, the controller 38 may generate control signals to control the drive motors 62.

### Front-Loading Refuse Vehicle

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck).

As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### Vehicle Connection Points

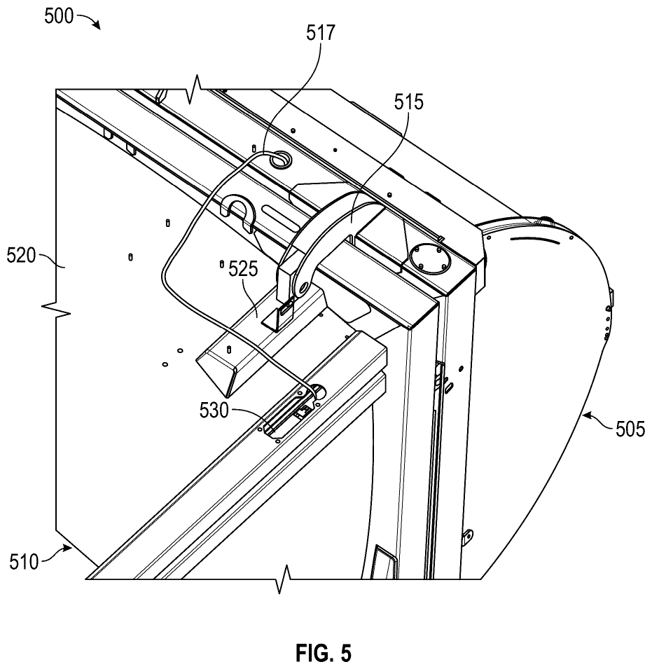

FIG. 5 depicts a perspective view of a vehicle 500. The vehicle 500 may include at least one of the vehicles described herein. For example, the vehicle 500 may include the vehicle 10. In some embodiments, the vehicle 500 may include one or more vehicle types. For example, the vehicle 500 is shown as a refuse vehicle. As another example, the vehicle 500 may be implemented as a boom lift. The vehicle 500 may provide some of the technical solutions described herein.

In some embodiments, the vehicle 500 may include at least one tailgate 505 and at least one body 510. The tailgate 505 can include at least one assembly. In some embodiments, the tailgate 505 can include one or more elements. For example, the tailgate 505 can include elements 515 and elements 517. FIG. 5 depicts an example of the elements 515 as an arm and an example of the elements 517 including a cord.

In some embodiments, the body 510 can include at least one face 520. For example, the body 510 can include one or more sides and the face 520 can include or define at least one of the sides of the body 510. FIG. 5 depicts an example of the face 520 as a top or upper face of the body 510. The face 520 may refer to and/or include one or more surfaces.

The body 510 can include at least one connection point. For example, the body 510 can include connection point 525 and connection point 530. In some embodiments, the connection point 525 can receive at least one element or component of the vehicle 500. For example, the connection point 525 can receive the element 515 of the tailgate 505. In some embodiments, the connection point 525 can couple the element 515 with the body 510. For example, the connection point 525 can be coupled with the body 510 and the connection point 525 can couple the element 515 with the body 510. The connection point 525 can couple the element 515 with the body 510 by at least one of attaching, mounting, securing, or otherwise connecting the element 515 with the body 510.

In some embodiments, the connection point 530 can receive at least one element of component of the vehicle 500. For example, the connection point 530 can receive the element 517. In some embodiments, the connection point 530 can be disposed adjacent to at least one portion of the body 510. For example, the connection point 530 can be disposed adjacent to the connection point 525. As an example, a distance between the connection point 530 and the connection point 525 may be less than 10 inches. As another example, the distance between the connection point 530 and the connection point 525 may be within arm's reach such that an operator of the vehicle may interact with either the connection point 530 and/or the connection point 525 from a single location or a single position. As another example, the connection point 530 and the connection point 530 may have a distance between one another that is within a range of 6 inches to 14 inches. As another example, the connection point 530 and the connection point 530 may have a distance between one another that is within a range of zero inches (e.g., in contact) to 7 inches. In some embodiments, the face 520 can include the connection point 525 and the connection point 530.

In some embodiments, the connection point 525 may refer to and/or include a mechanical connection. For example, the connection point 525 may receive the element 515 of the tailgate 505 and the connection point 525 may couple the element 515 with the body 510. In some embodiments, the connection point 530 may refer to and/or include an electrical connection. For example, the connection point 530 may receive the element 517 and the connection point 530 may electrically couple the element 517 with the body 510. In some embodiments, the connection point 530 may establish communication between the element 517 and the vehicle 500. For example, the connection point 530 may connect a hydraulic system to the body 510 and the connection may provide (e.g., communicate) fluid to power the hydraulic system. In some embodiments, the connection point 530 may establish communication by at least one of establishing a fluid connection between one or more components or electrically coupling one or more components.

As shown in FIG. 5, the connection point 525 and the connection point 530 are shown proximate to one another. In some embodiments, the location (e.g., proximate to) of the connection point 525 and the connection point 530 may provide several advantages. For example, an operator or an installer of the tailgate 505 may access both connection points (e.g., connection points 525 and 530) from a single location.

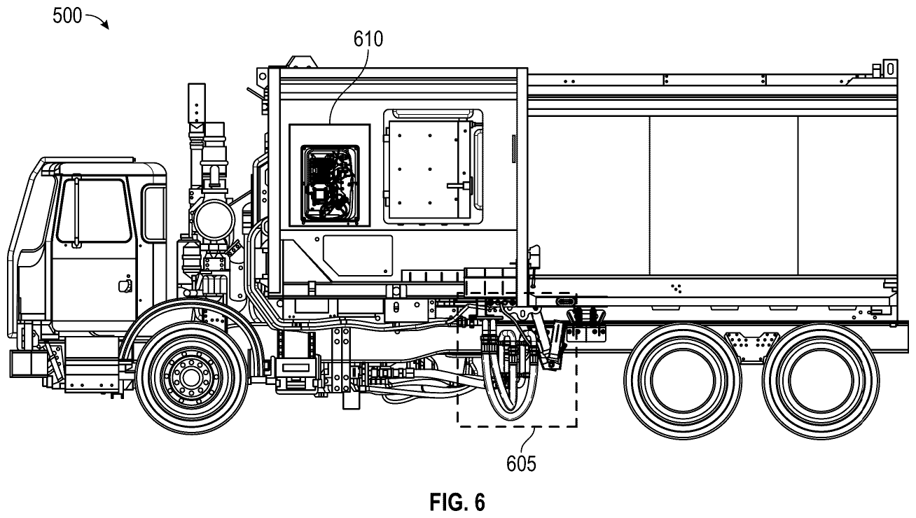

FIG. 6 depicts a side view of the vehicle 500. In some embodiments, the vehicle 500 may include one or more areas. For example, the vehicle 500 may include a front area, a side area, a top area, a rear area, and a bottom area. As shown in FIG. 6, the vehicle 500 includes one or more connection points on a side area of the vehicle 500 (illustrated as highlighted portion 610) and the vehicle 500 includes on or more connection points on a bottom area of the vehicle 500 (illustrated as highlighted portion 605). In some embodiments, the connection points may include at least one of the various connection points described herein. In some embodiments, the connection points may refer to and/or include connection points for one or more elements of the vehicle 500. The highlighted portion 610 may refer to and/or represent one or more junctions of the vehicle 500. For example, the junctions can include first junctions, second junctions, and third junctions.

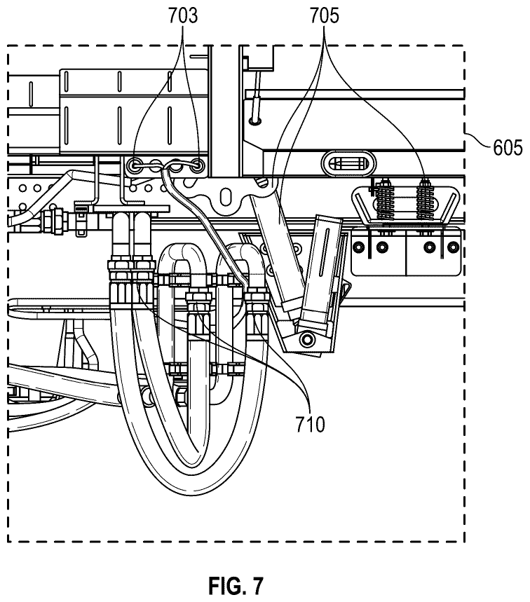

FIG. 7 depicts a perspective view of highlighted portion 605. The highlighted portion 605, as shown in FIG. 7, may include a zoomed in and/or enlarged view. The highlighted portion 605 can include one or more elements of the vehicle 500. For example, the highlighted portion 605 may include a chassis. As another example, the highlighted portion 605 may include an undercarriage of the vehicle. The chassis may be connected with the vehicle 500 via one or more connection points. For example, the chassis may be connected with the vehicle 500 via connections 703, 705, and 710. In some embodiments, the connections 703 may include electrical connections between the chassis and the vehicle 500. For example, the connections 703 may include electrically coupling the chassis to a power source of the vehicle 500.

In some embodiments, the connection 705 may include mechanical connections between the chassis and the vehicle 500. For example, the connections 705 may couple the chassis with the body 510. The connections 705 may refer to and/or include at least one junction. In some embodiments, the connections 710 may include fluid connections between the chassis and the vehicle 500. For example, the connections 710 may establish a fluid communication between the chassis and a hydraulic system that powers or supports the chassis. The connections 710 may refer to and/or include at least one junction.

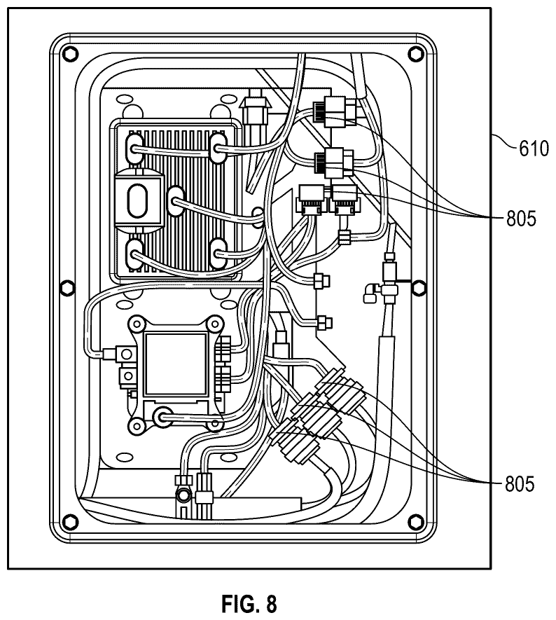

FIG. 8 depicts a perspective view of highlighted portion 610. The highlighted portion 610, as shown in FIG. 8, may include a zoomed in and/or enlarged view. The highlighted portion 610 can include one or more elements of the vehicle 500. For example, the highlighted portion 610 may include an electrical panel for the vehicle 500. The electrical panel may be coupled with the vehicle 500. For example, the electrical panel may be bolted or otherwise attached to the body 510. The electrical panel can include one or more connection points. For example, the electrical panel can include connection points 805. In some embodiments, the connection points 805 may electrically couple one or more elements of the vehicle 500. In some embodiments, the location of the connection points 805 of the electrical panel may assist during an assembly of the vehicle 500. For example, the connection points 805 may be located proximate to and/or adjacent to apertures of the electrical panel that receive fasteners to couple the electrical panel with the vehicle 500. The location of the connection points 805 proximate to the apertures may allow for an installer to access the connection points 805 while coupling the electrical panel to the vehicle 500.

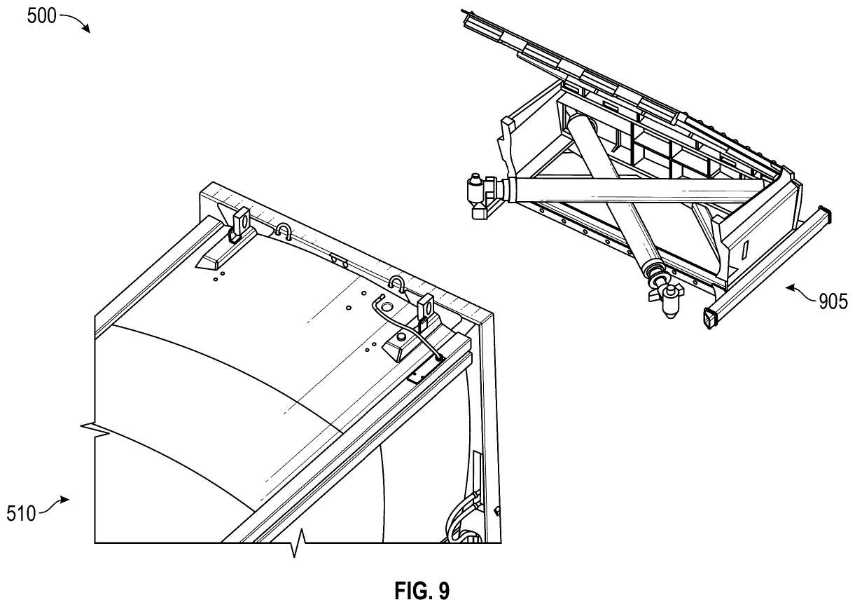

FIG. 9 is a perspective view of the vehicle 500. The vehicle 500 can include at least one ejector (shown as ejector panel 905). The ejector panel 905 may be disposed within the body 510. For example, the ejector panel 905 may be located, placed, or otherwise positioned within the body 510. The ejector panel 905 can include at least one eject cylinder. In some embodiments, the placement or location of the eject cylinders within the ejector panel 905 may correspond to a location or a placement of a connection point of the body 510. For example, the eject cylinders may be placed on the ejector panel 905 so that when the ejector panel 905 is inserted into the body 510 the eject cylinders are located adjacent to a connector pin and a hydraulic connection.

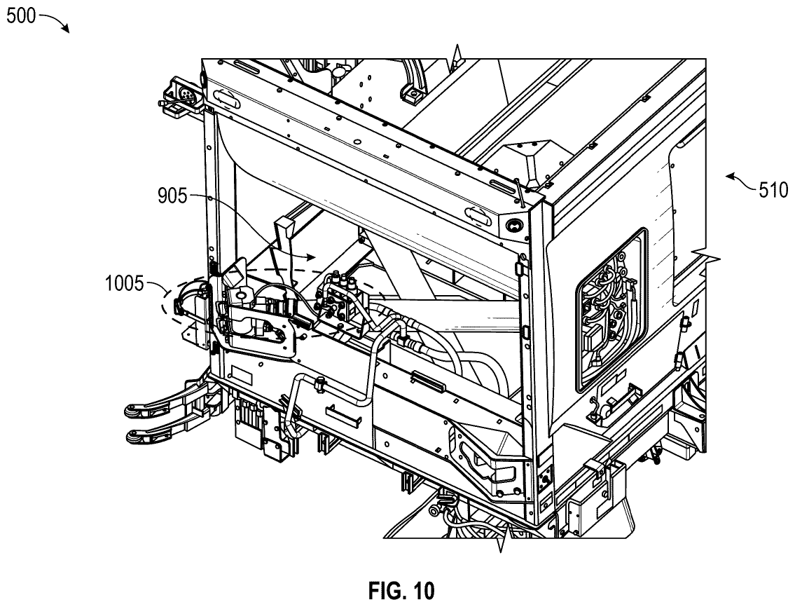

FIG. 10 is a perspective view of the vehicle 500. FIG. 10 depicts an example of the ejector panel 905 inserted within the body 510 of the vehicle 500. The ejector panel 905 may be located in a frontward portion of the body 510. The vehicle 500 may include one or more connection points towards the front area of the vehicle 500 (shown as highlighted portion 1005). In some embodiments, the connection points towards the front area of the vehicle 500 may be accessible from outside of and/or external to the vehicle 500. Stated otherwise the connection points may be assessable without first having to enter the body 510.

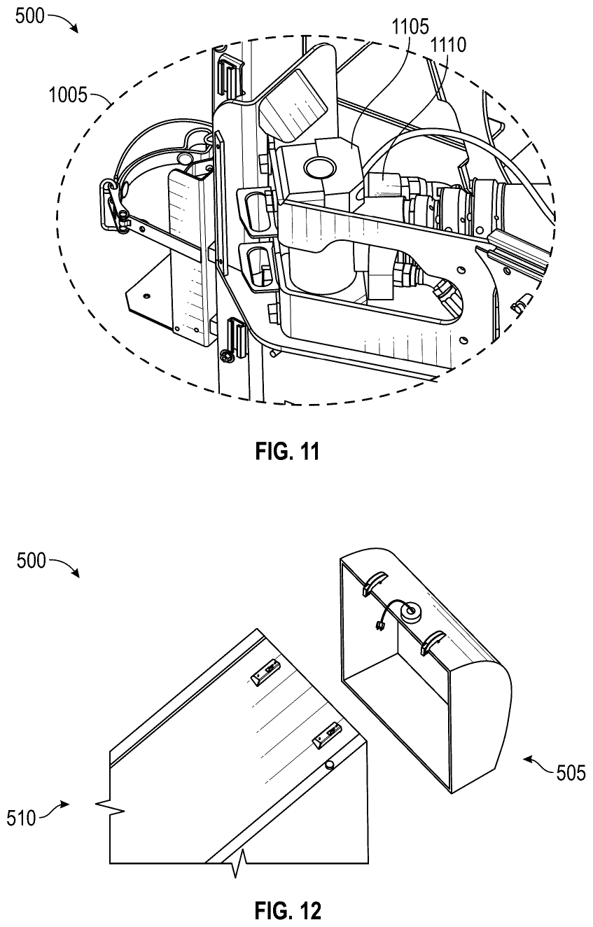

FIG. 11 depicts a perspective view of highlighted portion 1005. The highlighted portion 1005, as shown in FIG. 7, may include a zoomed in and/or enlarged view. The highlighted portion 1005 can include one or more elements of the vehicle 500. For example, the highlighted portion 1005 may include the eject cylinder and a frame of the body 510. The eject cylinder may be connected to the body 510 via one or more connection points. For example, the eject cylinder may be coupled with the body 510 via connections 1105. In some embodiments, the connections 1105 may include mechanical connections. The eject cylinder may have fluid communication established via connections 1110. For example, the connections 1110 may establish fluid communication between the eject cylinder and a hydraulic system of the vehicle 500.

FIG. 12 is a perspective view of the vehicle 500. In some embodiments, the tailgate 505 may include at least one storage or housing for the element 517. For example, the tailgate 505 may include a hollow portion and the hollow portion can house or store the element 517. In some embodiments, the hollow portion may house the element 517 during transportation of the tailgate 505. The element 517 may be releasable and/or movable, from the hollow portion.

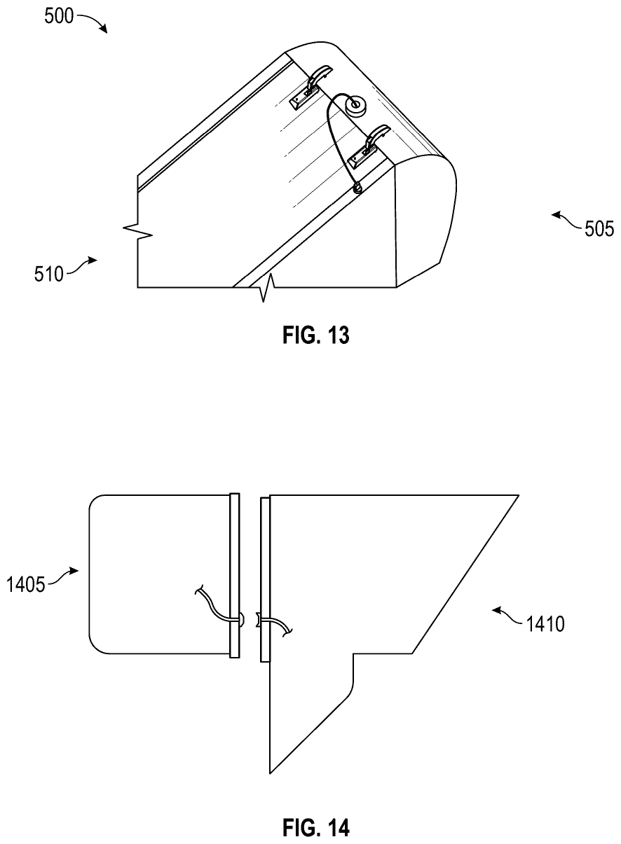

FIG. 13 is a perspective view of the vehicle 500. In some embodiments, the tailgate 505 may include one or more clipping points. The clipping points may be located proximate to the hollow portion that houses the element 517. The clipping points may be cut and/or removed to free or otherwise relocate the element 517 from the hollow portion. For example, the element 517 may be releasable from the hollow portion responsive to removal of the clipping points (e.g., fasteners).

FIG. 14 is a perspective view of the vehicle 500. The vehicle 500 may include one or more elements that define or otherwise establish a bulkhead. For example, elements 1405 and elements 1410 may define a bulkhead for the vehicle 500. The elements 1405 and the elements 1410 may include one or more connection points. For example, the elements 1405 and the elements 1410 may include electrical connection points and mechanical connection points. In some embodiments, the electrical connection points may move from a first position to a second position responsive to the elements 1405 and the element 1410 having been coupled with one another. For example, the electrical connection points may move from a first position to a second position responsive to the element 1410 being mounted to the element 1405. FIG. 14 depicts an example of the elements 1410 and the elements 1405 in a first position.

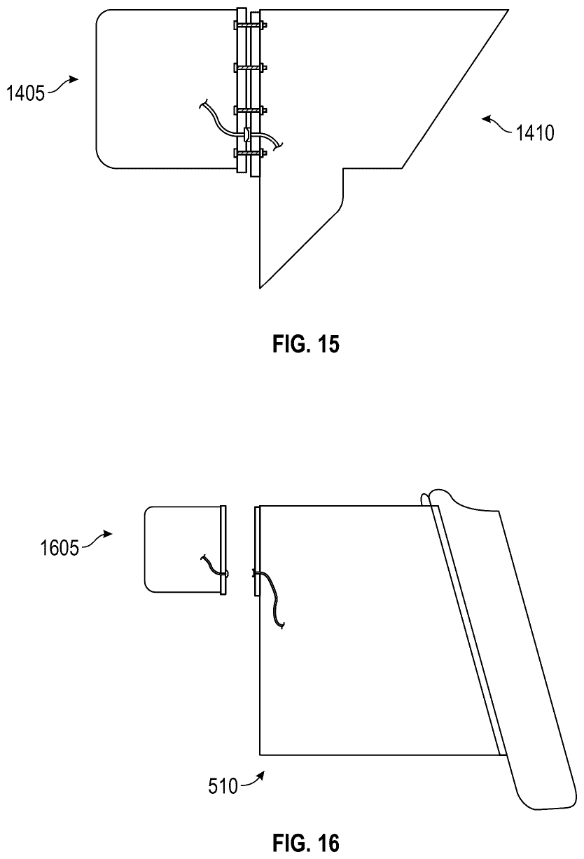

FIG. 15 is a perspective view of the vehicle 500. FIG. 15 depicts an example of the elements 1405 and the elements 1410 coupled with one another. In some embodiments, the coupling of the elements 1405 and the element 1410 may define a bulkhead of the vehicle 500. As shown in FIG. 15, the electrical connections of the elements 1410 and the elements 1405 have moved to a second position. Stated otherwise, the mechanical and/or structural connections established by coupling the element 1405 with the element 1410, has caused an alignment between electrical connectors of each element. In some embodiments, communication may be established between the electrical connections of the elements 1410 and the elements 1405 responsive to the elements 1405 and the elements 1410 having been coupled with one another. For example, the electrical connections may electrically couple with one another.

FIG. 16 is a perspective view of the vehicle 500. The vehicle 500 may include at least one element 1605. In some embodiments, the element 1605 may couple with the body 510. For example, the element 1605 may be mounted, secured, attached, or connected to the body 510. The coupling of the element 1605 with the body 510 may locate and/or position electrical connection points of the element 1605 proximate to electrical connection points of the body 510.

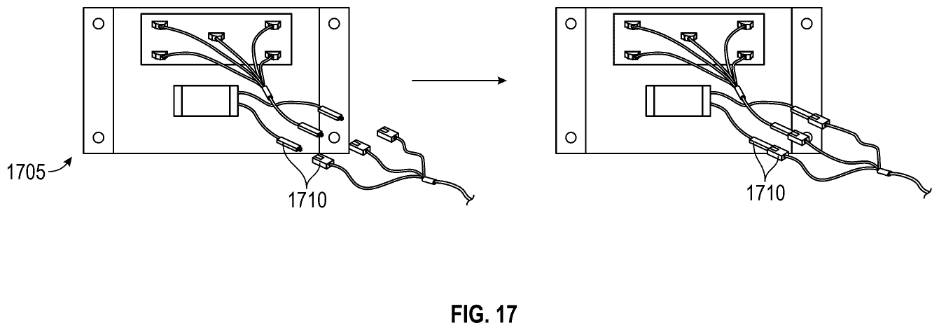

FIG. 17 is a perspective view of an electrical panel 1705. In some embodiments, the electrical panel 1705 can couple with the vehicle 500. For example, the electrical panel 1705 can be coupled with the body 510 of the vehicle 500. The electric panel 1705 may refer to and/or include at least one junction. In some embodiments, the body 510 may include a recess, an opening, and/or or cavity and the electrical panel 1705 may be inserted into the recess to place the electrical panel 1705 within the vehicle 500. In some embodiments, the electrical panel 1705 may include connections 1710. For example, the connections 1710 may include electrical connections and the connections 1710 can electrically couple with a power system of the vehicle 500. In some embodiments, the electrical connections (e.g., the connections 1710) can be made as the electrical panel 1705 is positioned or placed within the vehicle 500. For example, the electrical panel 1705 can be bolted (e.g., coupled) to the body 510 and as the electrical panel 1705 is coupled with the body 510 the electrical connections may be made (e.g., electrically coupled). As another example, the coupling of the electrical panel 1705 with the body 510 can cause alignment of the connections 1710 with one or more connections of the body. The establishment of the electrical connections as the electrical panel 1705 is coupled with the vehicle may decrease assembly time of the vehicle 500. For example, the electrical panel 1705 may be coupled or affixed to the vehicle 500 and at the same point the electrical panel 1705 may also be electrically coupled with the vehicle 500.

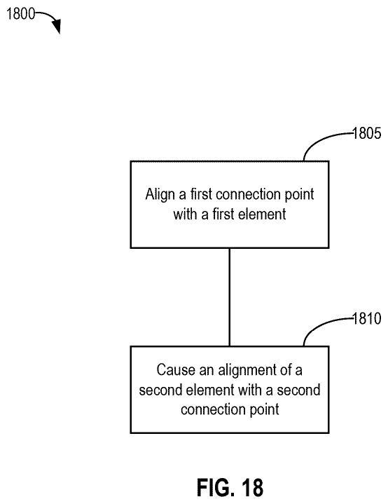

FIG. 18 depicts a flow diagram of a method 1800, according to an exemplary embodiment. The method 1800 can pertain to and/or include an assembly of one or more components of a vehicle. For example, the method 1800 may be perform to assembly one or more components of the vehicle 500. In some embodiments, the method 1800 may be performed at one or more points during assembly of a vehicle. For example, the method 1800 may be performed during a final assembly process of the vehicle 500.

In some embodiments, at step 1805, a first connection point may be aligned with a first element. For example, the connection point 525 can be aligned with the element 515. The aligning of the connection point 525 with the element 515 can occur as the tailgate 505 is moved towards and/or placed proximate to the body 510. For example, the element 515 can be positioned near the connection point 525 once the tailgate is attached or otherwise in contact with the body 510. The first connection point can structurally couple the tailgate 505 (e.g., an assembly) with the body 510. For example, the element 515 can be bolted to and/or otherwise attached to the connection point 525.

In some embodiments, at step 1810, alignment of a second element with a second connection point may be caused. For example, the element 515 may be caused to align with the connection point 530 responsive to the establishment of the connection between the connection point 530 and the element 515. As another example, the connection 710 may be caused to alignment responsive to establishment of the connections 705. In some embodiments, the second connection point can receive the second element. For example, the element 517 may be inserted into the connection point 530. As another example, hydraulic cords or hydraulic hoses may be inserted into the connections 710. The second connection point can provide at least one of an electrical connection or a hydraulic connection. For example, the second connection point can couple the second element with one or more batteries of a vehicle. As another example, the second connection point can couple the second element with a hydraulic system of a vehicle.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle, comprising:
an assembly;
a body;
a first connection point disposed on a surface of the body, and the first connection point configured to:
receive a first element of the assembly; and
couple the first element with the body to provide structural support to at least one of the assembly or the body; and
a second connection point disposed on the surface of the body and adjacent to the first connection point, and the second connection point configured to:
receive a second element of the assembly that is configured to provide an electrical connection or a hydraulic connection between the body and the assembly.

2. The vehicle of claim 1, further comprising:
the second connection point configured to:
establish, responsive to receipt of the second element, a second hydraulic connection between the assembly and a hydraulic system of the vehicle via the hydraulic connection between the body and the assembly; or
establish, responsive to receipt of the second element, an electrical coupling between the second element and one or more batteries of the vehicle.

3. The vehicle of claim 1, further comprising:
the first connection point configured to movably couple the first element with the body;
the assembly including a tailgate; and
the tailgate configured to move from a first position to a second position with the first element movably coupled with the body.

4. The vehicle of claim 3, further comprising:
the second connection point configured to establish a second hydraulic connection between one or more actuators of the second element and a hydraulic system of the vehicle; and
the one or more actuators configured to receive fluid power, from the hydraulic system, to move the tailgate from the first position to the second position.

5. The vehicle of claim 3, further comprising:
the second element configured to receive power, from one or more batteries of the vehicle, via the electrical connection.

6. The vehicle of claim 1, further comprising:
the assembly including a chassis of the vehicle; and
the chassis configured to support the body with the first element coupled with the body via the first connection point.

7. The vehicle of claim 6, further comprising:
the surface including an undercarriage of the vehicle;
the second connection point including one or more connectors disposed on the undercarriage;
the one or more connectors configured to provide fluid power from a hydraulic system of the vehicle; and
the second element configured to receive the fluid power, from the hydraulic system, via the one or more connectors, to support the chassis.

8. The vehicle of claim 1, further comprising:
the assembly including a compartment;
the compartment configured to house at least a portion of the second element; and
the second element releasable from the compartment responsive to removal of a fastener.

9. The vehicle of claim 1, further comprising:
a refuse compartment configured to store refuse;
the assembly disposable within the refuse compartment; and
the first connection point and the second connection point accessible from an area of the vehicle that is external to the refuse compartment.

10. The vehicle of claim 1, wherein alignment of the first element of the assembly and the body, via the first connection point, causes alignment of the second element of the assembly and the body.

11. The vehicle of claim 1, further comprising:
a third connection point on the assembly, the third connection point configured to support the second element in alignment with the second connection point when the assembly is coupled with the body.

12. The vehicle of claim 11, wherein the second connection point is a support element configured to maintain the second element via the electrical connection or the hydraulic connection.

13. The vehicle of claim 1, wherein the first connection point is disposed on a first portion of the surface, and further comprising:
a third connection point disposed on a second portion of the surface, and the third connection point configured to:
receive a third element of a second assembly of the vehicle; and
couple the third element with the body; and
a fourth connection point disposed adjacent to the third connection point, and the fourth connection point configured to:
electrically couple the second assembly with one or more batteries of the vehicle; and
provide electrical power to the second assembly from the one or more batteries.

14. The vehicle of claim 1, wherein the first connection point is disposed on a first portion of the surface, and further comprising:
a third connection point disposed on a second portion of the surface, and the third connection point configured to:
receive a third element of a second assembly; and
couple the third element with the body; and
a fourth connection point disposed adjacent to the third connection point, and the fourth connection point configured to:
fluidly couple the second assembly with a hydraulic system of the vehicle; and
provide fluid power to the second assembly from the hydraulic system.

15. The vehicle of claim 1, wherein the assembly includes at least one of:
a tailgate;
a chassis;
an ejector; or
a bulkhead.

16. A method, comprising:
aligning a first connection point on a body of a vehicle with a first element of an assembly of the vehicle, the first connection point configured to support the assembly on the body; and
causing, responsive to aligning the first connection point, an alignment of a second element of the assembly with a second connection point on the body, wherein the second connection point is adjacent to the first connection point, and wherein the second connection point is configured to:
receive the second element of the assembly; and
provide an electrical connection or a hydraulic connection between the body and the assembly.

17. The method of claim 16, wherein the second element includes one or more actuators, and further comprising:
establishing, by the second connection point, the hydraulic connection between the body and the assembly; and
receiving, by the one or more actuators, via the second connection point, fluid power to move a tailgate of the vehicle from a first position to a second position.

18. The method of claim 16, further comprising:
establishing, by the second connection point, the electrical connection between the second element and one or more batteries of the vehicle; and
receiving, by the second element, power from the one or more batteries via the second connection point.

19. A body for a vehicle, the body comprising:
a first junction for structural connections between the body and one or more first assemblies of the vehicle;
a second junction for electrical connections between the body and one or more first elements of the vehicle; and
a third junction for hydraulic connections between the body and one or more second elements of the vehicle;
wherein the first junction, the second junction, and the third junction are adjacent to one another.

20. The body of claim 19, wherein establishment of the structural connections between the body and the one or more first assemblies causes alignment between (1) the body and the one or more first elements of the vehicle, and (2) the body and the one or more second elements of the vehicle.
